(19) United States
(12) Patent Application Publication
(10) Pub. No.: US 2014/0059538 A1
(43) Pub. Date: Feb. 27, 2014

(54) VIRTUAL MACHINE STATE TRACKING USING OBJECT BASED STORAGE

(71) Applicants: Peter Bookman, Sandy, UT (US); Chris R. Featherstone, South Jordan, UT (US)

(72) Inventors: Peter Bookman, Sandy, UT (US); Chris R. Featherstone, South Jordan, UT (US)

(73) Assignee: V3 SYSTEMS, INC., Salt Lake City, UT (US)

(21) Appl. No.: 13/592,243

(22) Filed: Aug. 22, 2012

(51) Int. Cl. G06F 9/455

(52) U.S. Cl. 718/1

(57) ABSTRACT

A virtual machine state tracking mechanism that uses object based storage in order to track state information for at least some of the virtual machines that are operating in an environment. In some cases, the virtual machine environment includes virtual machine appliances on which virtual machines are run, and a centralized storage. For one, some, or all of the virtual machines, a first portion of the virtual machine state may be kept on an appliance, whereas a second portion is kept on the centralized storage. In some cases, the object based storage is resident on an appliance within the virtual machine environment, and also stores the first portion of the virtual machine state as well as the state tracking information. The state tracking information may be used to efficiently check in and check out associated virtual machines.

### BACKGROUND

For more than 40 years, technologists have known that one way to lower computing costs is to simultaneously share resources across multiple components and/or machines. This concept eventually led to the so-called client/server networking model where multiple desktop computers were linked together to a server where files and printer resources could be shared. Given the success achieved in improved performance and lowered costs through virtual servers, companies have been diligently attempting to replicate their efforts with “virtual desktops”, which will now be explained.

As a user interfaces with a client computing system (hereinafter referred to as a “client”), the user is presented with a desktop environment. The desktop environment may include an intuitive visualization of various icons, windows, and other tools that that user may interact with to manipulate the various applications and environments offered by the desktop environment.

As events occur (such as user input), the desktop environment is processed in a manner that is appropriate given the event, resulting in perhaps some change to the state of the desktop environment. Conventionally, such desktop processing occurs on the client. However, desktop virtualization involves the offloading of the desktop processing to a location other the client (hereinafter referred to as a “centralized desktop location”), which location is perhaps even remote from the client. That offloaded location may be a server, a server cluster, or a server cloud.

The centralized desktop location maintains a virtual machine for each supported desktop environment. The virtual machine has access to all of the desktop state necessary to construct an image for how the desktop environment should appear. The virtual machine also manages the processing that serves up desktop images to the corresponding client, which are rendered by the client as they are received.

As the client interacts with the displayed desktop image, that client input is transmitted to the centralized desktop location. The corresponding virtual machine at the centralized desktop location interprets the client input, and processes the desktop. In response to this input, or in response to some other detected event, the virtual machine changes the state of the desktop if appropriate. If this changed state results in a change in how the desktop appears, the virtual machine constructs a different desktop image, and causes the centralized desktop location to transmit the altered desktop image to the client. From the user's perspective, this occurs often fast enough that the displayed desktop at the client is substantially immediately responsive to the user input at the client. The desktop as is exists on the centralized desktop location is often referred to as a “virtual desktop”, and the application-level logic on the centralized desktop that is used to process the desktop is often referred to a “virtual machine”.

Typically, the centralized desktop location may manage a number of virtual desktops for a corresponding number of clients. In some cases, the centralized desktop location may manage hundreds of virtual desktops. In some cases, the centralized desktop location is a physical machine, which is referred to herein as a “physical appliance” or simply, an “appliance”. The appliance provides software and data support (hereinafter referred to as the “soft support resources”) to the virtual machine(s). For instance, the operating system and certain applications may be provided by the physical appliance. Supporting data may also be included within the soft support resources. For instance, user data (such as persistent preference information) may also be stored by the physical appliance.

All of the software and data support resources are conventionally located on the physical machine itself. An alternative conventional solution occurs when an organization has multiple physical appliances. To provide backup, the organization will provide access to a storage area network (SAN) to multiple physical appliances, and store the soft support resources on the SAN. If a failure were to occur with a physical appliance, of if the user were to migrate closer to another physical appliance, the soft support resources for the virtual machine are still available on the SAN. Thus, an instance of the virtual machine may be constructed on the other physical appliance, and mapped to the corresponding soft support resources on the SAN, to effect recovery or migration of a virtual machine.

### BRIEF SUMMARY

At least one embodiment described herein relates to a system in which there is a virtual machine state tracking mechanism that uses object based storage in order to track state information for at least some of the virtual machines that are operating in a virtual machine environment. For instance, the virtual machine environment includes one or more virtual machine appliances on which virtual machines are run, and a centralized storage. For one particular virtual machine, and perhaps for more and perhaps even all, of the virtual machines in the virtual machine environment, a first portion of the virtual machine state is kept on the appliance, whereas a second portion is kept on the centralized storage. In some cases, the object based storage is resident on an appliance within the virtual machine environment, and also stores the first portion of the virtual machine state as well as the state tracking information. The use of object based storage has the potential to significantly improve the efficiency in which the tracking information may be maintained.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a virtual machine environment that includes a single appliance supporting multiple virtual machines, and in which the appliance using object-based storage to store and maintain state tracking information regarding portions of the virtual machine state;

FIG. 3 illustrates a virtual machine in conjunction with internal and external soft support resources; and

FIG. 4 illustrates a flowchart of a method for using object-based storage to store and maintain state tracking information regarding virtual machine state.

### DETAILED DESCRIPTION

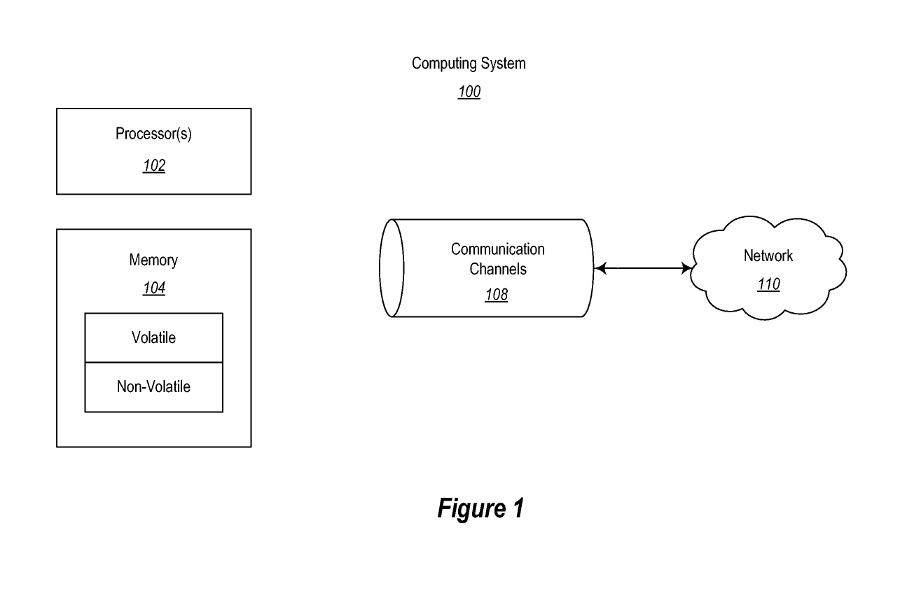

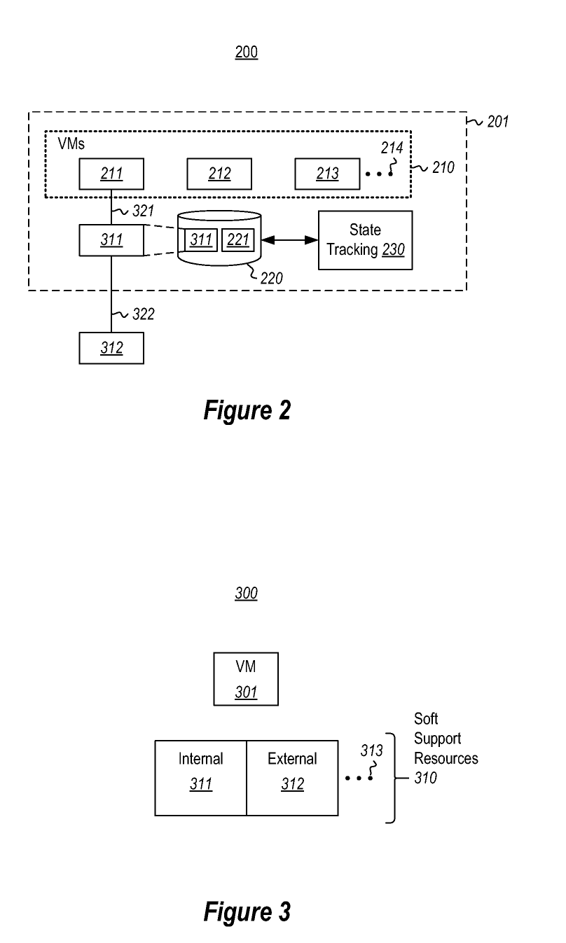

In accordance with at least one embodiment described herein, a system is described in which a virtual machine state tracking mechanism uses object based storage in order to track state information for at least some of the virtual machines that are operating in a virtual machine environment. For instance, the virtual machine environment includes one or more virtual machine appliances on which virtual machines are run, and a centralized storage. For one particular virtual machine, and perhaps for more and perhaps even all, of the virtual machines in the virtual machine environment, a first portion of the virtual machine state is kept on the appliance, whereas a second portion is kept on the centralized storage. In some cases, the object based storage is resident on an appliance within the virtual machine environment, and also stores the first portion of the virtual machine state as well as the state tracking information. The use of object based storage has the potential to significantly improve the efficiency in which the tracking information may be maintained. First, some introductory discussion regarding computing systems will be described with respect to FIG. 1. Then, embodiments of the state tracking using object-based storage will be described with respect to FIGS. 2 through 4.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a virtual machine environment 200. The environment 200 includes a physical support environment in the form of an appliance 201 in which a set of virtual machines 210 operate. The appliance 201 may thus be, for example, a virtual machine host computing system. There may be any number of virtual machines 210 operating in the physical support environment 201. In FIG. 2, there are three virtual machines 211, 212 and 213 shown, with ellipses 214 representing that the number of virtual machines 210 may be as few as one, but potentially as many thousands, or even more. Each virtual machine manages state (e.g., a desktop state) for a corresponding client that may perhaps be remotely located. The virtual machine provides an image representing a desktop image to the corresponding client, and alters the image or other desktop state in response to detected events, such as, for example, a user interfacing with the current desktop image.

As the client interacts with the displayed desktop image corresponding to a virtual machine, that client input is transmitted to the centralized environment 201. The corresponding virtual machine interprets the client input, and processes the client input. In response to this input, or in response to some other detected event, the virtual machine changes the state of the virtual desktop if appropriate. If this changed state results in a change in how the desktop appears, the virtual machine constructs and transmits another desktop image to the client. From the user's perspective, this occurs often fast enough that the displayed desktop is substantially immediately responsive to the user input.

Each virtual machine needs resources in order to operate properly. The appliance 200 provides a variety of support resources for each of the virtual machines 210. For instance, some of that support includes hard (physical) support resources such as processing resources, memory resources, storage resources, network access resources, and the like. For instance, the appliance 200 may be structured as described above for the computing system 100 of FIG. 1. In that case, the hard support resources may include processor(s) 102, memory 104, and communication channels 110.

Each virtual machine also uses soft support resources, such as software and data. As far as software, the virtual machine may use an operating system, one or more applications, and/or one or more other software modules. As far as data, the physical support environment 200 may host some or all of data that is used by the virtual machine in order to operate, such as user preference data, and other application state. The “soft” support resources are so named because the resources (such as software and data) are capable of being copied from one location to another, or accessed remotely over a network. For instance, the soft support resources may be a Virtual Machine Disk Format (VMDK) file.

Referring to FIG. 3, an appliance 300 is shown in which a virtual machine 301 is shown in conjunction with its soft support resources 310. The soft support resources 310 include a first portion 311, and a second portion 312. The ellipses 313 represent that there may be other portions of the soft support resources 310 as well. In accordance with the principles described herein, for each of at least some of the virtual machines operating in the appliance 201, a portion of the soft support resources are “internal” soft support resources in the sense that they are provided by the physical support environment 201, and a portion of the soft support resources are “external” in the sense that they are provided from a location that is external to the physical support environment.

For instance, referring to FIG. 2, the virtual machine 211 is illustrated as having a first soft support resource 311 that is internal to the appliance 201, and a second soft support resource 312 that is external to the appliance 201. In accordance with the embodiments described herein, the allocation of soft resources is made in a way that improves performance of the virtual machine, and which also allows for efficient migration of the virtual machine from one physical support environment to another.

For instance, in the embodiment in which the soft support resources 311 and 312 are collectively represented by a VMDK file, the operating system and the applications may be internal soft support resources, and the user data may be external soft support resources. This is, however, just an example, as the principles described herein may be applied to any case in which the desktop state is divided into at least N different pieces (where N is a positive integer that is two or greater), and where M of those pieces (where M is any positive integer less than N) are part of the internal soft support resource portion 311, and where N−M (read N minus M) of those pieces are part of the external soft support resource portion.

The appliance 201 also includes an object based storage 220. Object-based storage devices (sometimes referred to in the art as an “OSD”) contain data structures called “objects” that are variable-sized data-storage containers. Each object includes data and properties. The data is consumable by the entity (e.g., the application) requesting the objects. The properties include an object identifier, attributes, and metadata. The object-based storage device provides its own mechanism for allocating and placement of storage for the objects, rather than rely on a file system. Furthermore, the object-based storage device does not use a memory-intensive index to track objects. Rather than being a flat list of fixed-sized memory locations as is the case with block-based storage, the objects in an object-based storage device may be any size, and may be interrelated, and perhaps hierarchically structured, with related objects perhaps being distributed across multiple object-based storage devices. Such distributed object hierarchies are enabled by keeping the metadata for each object local to the application that accesses the hierarchy, while allowing the data itself to be distributed.

The appliance 201 also includes a virtual machine state tracking mechanism 230 that uses the object based storage 220 to store state tracking information 221 for the virtual machine 211, and for potentially each of some or potentially all of the virtual machines 210. The state tracking information 221 tracks a location and a state of the portions of the internal soft support resources 311, and a location and a state of the portions of the external soft support resources 312. The state tracking information 221 also tracks a state of the internal soft support resources 311 and the external soft support resources 312. For instance, this information may be used to determine which client machine needs which file in order to properly check out a virtual machine. As an example in the context of VMWare, the state tracking information 221 could be an index created by a transfer server.

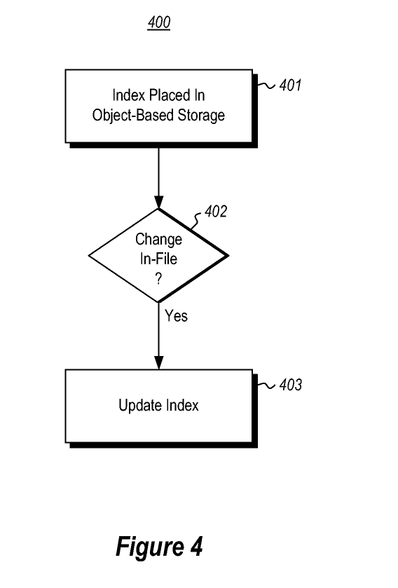

FIG. 4 illustrates a flowchart of a method 400 for tracking state associated with a virtual machine. The state tracking information is placed in a solid state storage (act 401). For instance, with reference to FIG. 2, the state tracking information 221 may be placed within the object based storage 220. As previously mentioned, the state tracking information may include an identification of each of multiple data portions (e.g., files) that define state for the associated virtual machine.

If a change occurs in one of the data portions (“Yes” in decision block 202), the state tracking information may also be updated to reflect that a change has been made (act 203). This tracking of such state information may be especially helpful in the context of allowing virtual machines to be checked in and checked out. For instance, suppose that there are N files required in order operate a virtual machine. If the client machine that operates using that virtual machine is to go into disconnected mode, that client is to no longer have access to the appliance (e.g., the appliance 201) that runs the virtual machine (e.g., the virtual machine 211). Accordingly, those N files that are required to operate the virtual machine state are needed on the client machine. The state tracking information may be used to determine which of the N files are to be transferred to the client machine. For instance, if the file is not truly necessary (or is not necessary to be updated) for the client machine to operate the virtual machine on the client machine itself, or if the file in its updated form already on the client machine, then the file need not be transferred to the client in preparation for going into disconnected mode. Thus, the state tracking information may be used to determine whether the file is to be transferred as part of the state tracking information.

While the client is in the disconnected mode, the client machine may make any number of changes to the virtual machine files that are then locally present on the client machine. When the client goes back into connected mode, the state tracking information may then be used to determine which files are to be transferred back from the client machine to the appliance to overwrite the previous files, and give the virtual machine the same state as existed on the client machine. If the user has multiple client machines, and a connected client machine were to make changes to the virtual machine files, then the state tracking information may track which files changed, and perhaps update any disconnected client machines associated with that user, or perhaps flag the change so that the change may be applied to the disconnected client machine the next time the client machine becomes connected again.

The formulation of such state tracking information can be computationally intensive, especially during times in which a client machine connects or disconnects. Furthermore, the computational intensity is increased by orders of magnitude when one considers that a single application host computing system may host many virtual machines, each perhaps having its own state tracking information, and each perhaps connects or disconnects at different times. There may be particular computations congestion when multiple client machines are trying to disconnect (e.g., at the end of a work day) or connect (e.g., at the beginning of the work day) at the same time.

Further complexity occurs in that each time the computation of the state tracking information moves from one virtual machine to another, the host computing system performs context switching of sorts. Because the state tracking information itself is located in object-based storage, such object-based storage is capable of handling such context switching in a much more efficient manner that conventional solid state storage that is not object-based, and especially compared to spinning media. Accordingly, the principles described herein provide a more efficient way of managing state tracking information associated with virtual machines, particularly in cases in which context switching occurs frequently as in the case of checking-in or checking-out virtual machines.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system that comprises:
a virtual machine environment that uses at least one processor to run a plurality of virtual machines;
object based storage; and
a virtual machine state tracking mechanism that uses the object based storage to store state tracking information for each of at least some of the plurality of virtual machines in the object based storage.

2. The system in accordance with claim 1, wherein the virtual machine environment comprises:
a particular virtual machine appliance on which virtual machines are run including a particular virtual machine, the particular virtual machine appliance also storing a first portion of virtual machine state for the particular virtual machine; and
a centralized storage mechanism that is external to, but accessible by, the particular virtual machine appliance, the centralized storage mechanism storing a second portion of virtual machine state for the particular virtual machine.

3. The system in accordance with claim 2, wherein the object based storage is resident on the particular virtual machine appliance.

4. The system in accordance with claim 3, wherein the object based storage also stores the first portion of the virtual machine state for the particular virtual machine.

5. The system in accordance with claim 2, the tracking information stored by the virtual machine state tracking mechanism tracking a location of the first portion of the virtual machine state and a location of the second portion of the virtual machine state.

6. The system in accordance with claim 2, wherein the first portion includes an operating system.

7. The system in accordance with claim 6, wherein the first portion includes one or more applications that use the operating system.

8. The system in accordance with claim 2, wherein the second portion of the support resources includes user data.

9. The system in accordance with claim 2, wherein the first portion of the support resources includes resources that are, on average, accessed more frequently than resources included in the second portion of the support resources.

10. The system in accordance with claim 1, the tracking information stored by the virtual machine state tracking mechanism tracking an identification of files that define a state of a particular virtual machine of the plurality of virtual machines.

11. The system in accordance with claim 1, wherein the virtual machine environment that uses at least one processor to run a plurality of virtual machines comprises a plurality of appliances, each capable of executing more than one virtual machine.

12. A computer program product comprising one or more computer-readable storage media having thereon one or more computer-executable instructions that are structured such that, when executed by one or more processors of a computing system, cause the computing system to instantiate in memory the following:
a virtual machine state tracking mechanism is configured to maintain tracking information in an object based storage for each of at least some virtual machines in a virtual machine environment by performing the following for each of the at least some virtual machines:
an act of placing the state tracking information for the associated virtual machine in the solid state storage, the state tracking information for the associated virtual machine including an identification of data that define state for the associated virtual machine;
an act of determining whether a portion of the data has changed; and
an act of updating the tracking information to reflect that the portion of the data has changed.

13. The computer program product in accordance with claim 12,
wherein the virtual machine environment comprises a particular virtual machine appliance on which virtual machines are run including a particular virtual machine, the particular virtual machine appliance also storing a first portion of virtual machine state for the particular virtual machine; and a centralized storage mechanism that is external to, but accessible by, the particular virtual machine appliance, the centralized storage mechanism storing a second portion of virtual machine state for the particular virtual machine,
the tracking information also representing a location of the portion of the data.

14. The computer program product in accordance with claim 13, wherein the data includes a plurality of files.

15. A method for tracking virtual machine state for a plurality of virtual machines in a virtual machine environment, the method comprising the following for each of at least some of the plurality of virtual machines:
an act of placing the state tracking information for the associated virtual machine in an object based storage, the state tracking information for the associated virtual machine including an identification of each of a plurality of data portions that defines state for the associated virtual machine; and
for at least one of the plurality of data portions, an act of update the tracking information to reflect a change in the data portion in at least some cases when it is determined that the data portion has changed.

16. The method in accordance with claim 15, wherein the plurality of data portions are a plurality of files.

17. The method in accordance with claim 15, wherein the state tracking information is used to check out the associated virtual machine.

18. The method in accordance with claim 19, wherein upon checking in the associated virtual machine, the state tracking information is updated.
